(19) United States
(12) Patent Application Publication
(10) Pub. No.: US 2015/0053349 A1
(43) Pub. Date: Feb. 26, 2015

(54) CORRUGATED SHEET MANUFACTURING APPARATUS

(71) Applicant: Kabushiki Kaisha Isowa, Aichi (JP)

(72) Inventors: Naoki Mori, Kasugai-shi (JP); Mitsuhiro Ishizuka, Kasugai-shi (JP)

(73) Assignee: Kabushiki Kaisha Isowa, Aichi (JP)

(21) Appl. No.: 13/975,909

(22) Filed: Aug. 26, 2013

(51) Int. Cl. B31F 1/28; B31F 1/26; B31F 1/24

(52) U.S. Cl. CPC B31F 1/2831; B31F 1/24; B31F 1/26
USPC 156/355

(57) ABSTRACT

The present invention provides a corrugated sheet manufacturing apparatus (1) which includes a single facer (8), a double facer (14), and a cutter machine (16). The single facer includes a flute pitch calculation unit for calculating and setting a value of the flute pitch of the medium in such a manner that the given cut length for the double-faced corrugated sheet becomes equal to an integral multiple of the flute pitch of the medium; a flute pitch detection unit for detecting a flute pitch of the single-faced corrugated sheet; and a brake controller (44) for adjusting a tension of a liner being fed into the single facer to allow the detected flute pitch of the single-faced corrugated sheet to become equal to the set flute pitch.

### TECHNICAL FIELD

The present invention relates to a corrugated sheet manufacturing apparatus, and more particularly to a corrugated sheet manufacturing apparatus for manufacturing a corrugated sheet, on which a plurality of fold lines (score and crease lines) are formed, and which are folded and joined along positions of the fold lines to produce a corrugated box, using a box making machine.

### BACKGROUND ART

A corrugated sheet manufacturing apparatus for manufacturing a corrugated sheet comprises: a single facer for producing a single-faced corrugated sheet by bonding a medium and a liner together; a double facer for producing a double-faced corrugated sheet by bonding another liner to the single-faced corrugated sheet; a slitter-scorer unit for slitting and scoring the double-faced corrugated sheet along a moving direction of the sheet; and a cutter machine for cutting the double-faced sheet into a plurality of sheets each having a given cut length in the moving direction of the sheet.

In this type of the corrugated sheet manufacturing apparatus, during the process of producing a single-faced corrugated sheet by a single facer, a medium formed with wave-shaped flutes undergoes a change in flute pitch length, according to a temperature and a water content of paper, a tension applied to the liner, and others, which causes phase deviation, resulting in occurrence of various problems.

Therefore, for example, JP 2786620B describes a corrugated sheet manufacturing apparatus which comprises: a first single facer for bonding, to a liner, a first core board (first medium) formed in a wave shape; and a second single facer for bonding, to the first core board, a second core board (second medium) formed in a given wave shape in such a manner as to become coincident with the wave shape of the first core board, wherein, when a phase deviation between the wave shapes of the first and second core boards occurs, a tension of a single-faced corrugated sheet formed by the first single facer is adjusted to allow phases of the two wave shapes to become coincident with each other.

JP 2002-36388A (see Paragraph [0005]) describes a corrugated box making machine, wherein, considering that a level of foldability during folding using a folder-gluer varies depending on whether a crease line is formed at an intermediate position between adjacent ones of a plurality of flute tips of a corrugated sheet or at a position around one of the flute tips, causing the occurrence of a folding defect, a second crease-line forming tool separate from an existing crease-line forming tool is provided to form a crease line in a corrugated sheet by these crease-line forming tools.

### SUMMARY OF THE INVENTION

### Technical Problem

In a corrugated sheet manufactured using a corrugated sheet manufacturing apparatus, during a process of producing a single-faced corrugated sheet by a single facer, a medium undergoes a change in flute pitch length, according to a temperature and a water content of paper, a tension applied to a liner, and others, which causes phase deviation, i.e., causes a situation where a plurality of corrugated sheets become non-uniform in terms of a phase of each flute tip, as mentioned above. This leads to a problem of a large variation in level of foldability at positions of crease lines to be formed in respective ones of the corrugated sheets during a subsequent box making step using a box making machine, thereby causing deterioration in joining accuracy, and failing to uniformize a box size. This problem has not yet been solved, and there is a need for solving the problem.

In the above circumstances, the present invention has been made to comply with the longstanding demand, and an object thereof is to provide a corrugated sheet manufacturing apparatus capable of adjusting a phase of each flute pitch of a medium during production of a single-faced corrugated sheet, to allow a plurality of corrugated sheets to become uniform in terms of a phase of each flute pitch of the medium, with respect to a position of a crease line to be formed in each of the corrugated sheets during a subsequent box making step using a box making machine, thereby providing enhanced joining accuracy and uniformized box size.

### Solution to the Technical Problem

In order to achieve the above object, the present invention provides a corrugated sheet manufacturing apparatus for manufacturing a corrugated sheet, on which a plurality of fold lines are formed, and which are folded and joined along positions of the fold lines to produce a corrugated box, using a box making machine. The corrugated sheet manufacturing apparatus comprising: a single facer for producing a single-faced corrugated sheet by bonding a liner to a medium formed with a plurality of flutes having a given flute pitch to produce; a double facer for producing a double-faced corrugated sheet by bonding another liner to the single-faced corrugated sheet; and a cutter machine for cutting the double-faced corrugated sheet into a plurality of sheets each having a given cut length in a moving direction of the sheet. The single facer comprises: a flute pitch calculation unit for calculating and setting a value of the flute pitch of the medium in such a manner that the cut length for the double-faced corrugated sheet becomes equal to an integral multiple of the flute pitch of the medium; a flute pitch detection unit for detecting a flute pitch of the single-faced corrugated sheet fed out from the single facer; and a tension adjustment unit for adjusting a tension of a liner being fed into the single facer to allow the flute pitch of the single-faced corrugated sheet detected by the flute pitch detection unit to become equal to the flute pitch set by the flute pitch calculation unit.

According to the above feature of the present invention, the flute pitch of the medium is set in the single facer in such a manner that the cut length for the double-faced corrugated sheet becomes equal to an integral multiple of the set flute pitch of the medium, so that it becomes possible to allow a plurality of corrugated sheets each cut to the length in the moving direction of the sheet to become uniform in terms of the flute tip phase. In addition, a flute pitch of the single-faced corrugated sheet fed out from the single facer is detected, and a tension of a liner being fed into the single facer is adjusted to allow the detected actual flute pitch of the single-faced corrugated sheet to become equal to the set flute pitch. Thus, it becomes possible to allow a plurality of corrugated sheets to become uniform in terms of a flute phase with respect to at a position of a crease line in each of the corrugated sheets during the folding using the box making machine, thereby providing enhanced joining accuracy of the corrugated sheet and uniformized box size, in a box making step.

Preferably, in the present invention, the flute pitch detection unit comprises: an image detection device provided on the side of an outlet of the single facer to detect an image of a surface of the fed-out single-faced corrugated sheet; and an image processing device for processing the image detected by the image detection device to detect the flute pitch of the single-faced corrugated sheet.

According to this feature of the present invention, an image of the surface of the fed-out single-faced corrugated sheet is detected, and the detected image is processed to detect the flute pitch, so that it becomes possible to accurately detect the flute pitch of the fed-out single-faced corrugated sheet, thereby providing enhanced joining accuracy of the corrugated sheet and uniformized box size, in a subsequent box making step.

Preferably, in the present invention, the single facer comprises a press roller for pressing the liner against the medium to bond them together, wherein the image detection device detects a plurality of press marks formed on a surface of the liner by the press roller.

According to this feature of the present invention, the image detection device detects a plurality of press marks formed on the surface of the liner by the press roller, so that it becomes possible to reliably detect a phase deviation of each flute pitch, thereby providing enhanced joining accuracy of the corrugated sheet and uniformized box size, in the subsequent box making step.

Preferably, in the present invention, the image detection device detects an image of a plurality of flute tips of the single-faced corrugated sheet.

According to this feature of the present invention, the image detection device detects an image of the plurality of flute tips of the single-faced corrugated sheet, so that it becomes possible to reliably detect a phase deviation of each flute pitch, thereby providing enhanced joining accuracy of the corrugated sheet, in the subsequent box making step, thereby providing enhanced joining accuracy of the corrugated sheet, and uniformized box size, in the subsequent box making step.

Preferably, in the present invention, the image detection device is a CCD camera.

According to this feature of the present invention, a CCD camera is used as the image detection device, so that it becomes possible to detect a phase deviation of each flute pitch, simply and accurately.

Preferably, in the present invention, the cutter machine comprises: a flute tip phase detection unit for, before the cutting of the double-faced corrugated sheet, detecting actual phases of a plurality of flute tips of the double-faced corrugated sheet; and a speed control unit for, when, with respect to a flute tip phase at an intended cut position, a corresponding one of the phases of the flute tips of the double-faced corrugated sheet detected by the flute tip phase detection unit has a deviation, controlling a rotational speed of a cutting tool of the cutter machine, thereby correcting an amount of the deviation to fall within a given range.

According to this feature of the present invention, in the situation where, before the cutting of the double-faced corrugated sheet, with respect to a flute tip phase at an intended cut position, a corresponding one of the actual phases of the flute tips of the double-faced corrugated sheet has a deviation, an amount of the deviation is corrected to fall within a given range, so that it becomes possible to provide further enhanced joining accuracy of the corrugated sheet and uniformized box size, in the subsequent box making step.

Preferably, in the present invention, the flute tip phase detection unit comprises: an image detection device for detecting an image of a surface of the double-faced corrugated sheet; and an image processing device for processing the image detected by the image detection device to detect the actual phases of the flute tips of the double-faced corrugated sheet.

According to this feature of the present invention, the image detection device detects an image of the surface of the double-faced corrugated sheet, and the image processing device processes the detected image, so that it becomes possible to accurately detect the actual phases of the flute tips of the double-faced corrugated sheet, thereby providing further enhanced joining accuracy of the corrugated sheet and uniformized box size, in the subsequent box making step.

### Effect of the Invention

The corrugated sheet manufacturing apparatus of the present invention is capable of adjusting a phase of each flute pitch of a medium during production of a single-faced corrugated sheet, to allow a plurality of corrugated sheets to become uniform in terms of a phase of each flute pitch of the medium, with respect to a position of a crease line to be formed in each of the corrugated sheets during a subsequent box making step using a box making machine, thereby providing enhanced joining accuracy and uniformized box size.

### BRIEF DESCRIPTION OF THE DRAWINGS

FIG. 1 is a side view generally illustrating a corrugated sheet manufacturing apparatus according to one embodiment of the present invention.

FIG. 2 is a side view illustrating a single facer, a liner mill roller stand, and a splicer of the corrugated sheet manufacturing apparatus according to the embodiment of the present invention.

FIG. 3 is a fragmentary enlarged sectional view illustrating a single-faced corrugated sheet.

FIG. 4 is a side view illustrating a cutter machine of the corrugated sheet manufacturing apparatus according to the embodiment of the present invention.

FIG. 5 is a flowchart illustrating a control flow in the single facer of the corrugated sheet manufacturing apparatus according to the embodiment of the present invention.

FIG. 6 is a flowchart illustrating a control flow in the single facer of the corrugated sheet manufacturing apparatus according to the embodiment of the present invention,

FIG. 7(A) is a top plan view illustrating a double-faced corrugated sheet manufactured by the corrugated sheet manufacturing apparatus according to the embodiment of the present invention, and FIG. 7(B) is a side view of a plurality of corrugated sheets manufactured by the corrugated sheet manufacturing apparatus according to the embodiment of the present invention.

FIG. 8(A) is a top plan view illustrating a double-faced corrugated sheet manufactured by the corrugated sheet manufacturing apparatus according to the embodiment of the present invention, and then processed by a box making machine, and a sectional view viewed along the line A-A in the top plan view, and FIG. 8(B) is a fragmentary sectional view at each crease line in each of a plurality of double-faced corrugated sheets.

FIG. 9 is a top plan view illustrating a bonded region of a corrugated sheet bonded during a box making step.

FIG. 10 is a diagram illustrating a variation in amount of gap in a bonded region of each of two types of corrugated sheets manufactured, respectively, by a conventional corrugated sheet manufacturing apparatus and the corrugated sheet manufacturing apparatus according to the embodiment of the present invention.

### DESCRIPTION OF EMBODIMENTS

With reference to the accompanying drawings, a corrugated sheet manufacturing apparatus according to one embodiment of the present invention will now be described.

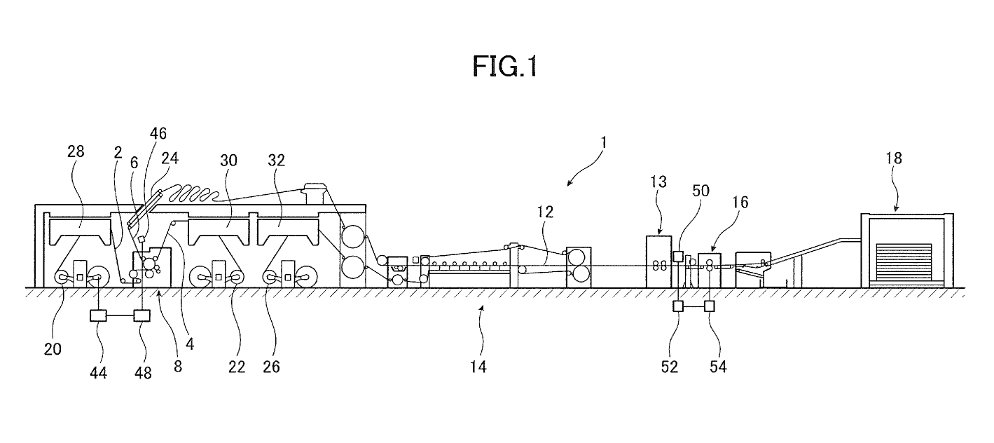

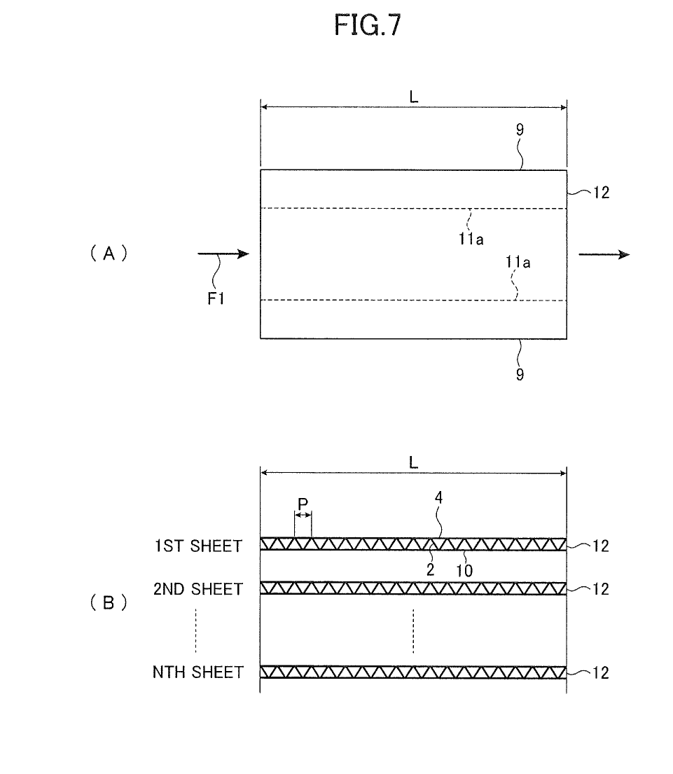

First of all, based on FIG. 1, a general structure of the corrugated sheet manufacturing apparatus according to the embodiment of the present invention will be described. The reference numeral 1 denotes the corrugated sheet manufacturing apparatus (corrugator machine) according to the embodiment of the present invention. The corrugated sheet manufacturing apparatus 1 comprises: a single facer 8 for bonding a liner 4 to a medium 2 formed with a plurality of flutes having a given flute pitch P to produce a single-faced corrugated sheet 6; a double facer 14 for bonding another liner 10 to the single-faced corrugated sheet 6 to produce a double-faced corrugated sheet 12; a slitter-scorer 13 for slitting (see a slit 9 in FIG. 7(A)) and scoring (see a score line 11a in FIG. 7(A)) the double-faced corrugated sheet 12 along a moving direction F1 (i.e., along a direction perpendicular to the flutes); a cutter machine 16 for cutting the double-faced corrugated sheet 12 into a plurality of sheets each having a given cut length L in the moving direction F1 of the sheet; and a stacker machine 18 for stackingly receiving therein the cut double-faced corrugated sheets.

As illustrated in FIG. 1, the corrugated sheet manufacturing apparatus 1 further comprises: a medium mill roller stand 20 for feeding a medium to the single facer 8; a liner mill roller stand 22 for feeding a liner 4 to the single facer 8; a take-up conveyer 24 for feeding the single-faced corrugated sheet 6 produced by the single facer 8 to the double facer 14; and a liner mill roller stand 26 for feeding another liner 10 to the double facer 14. The mill roller stands 20, 22, 26 are equipped, respectively, with paper-splicing splicers 28, 30, 32.

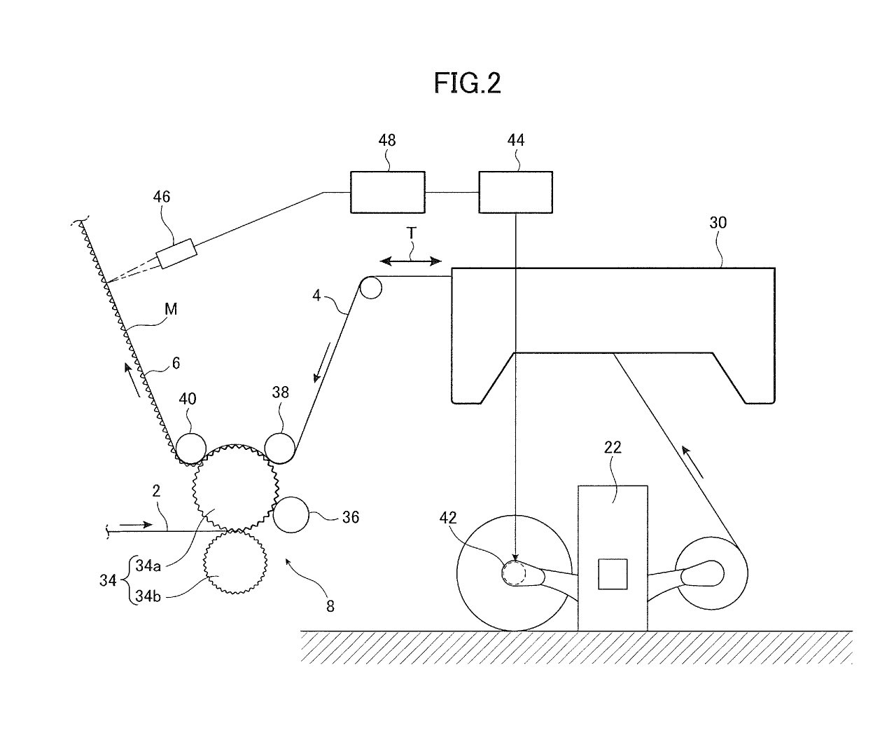

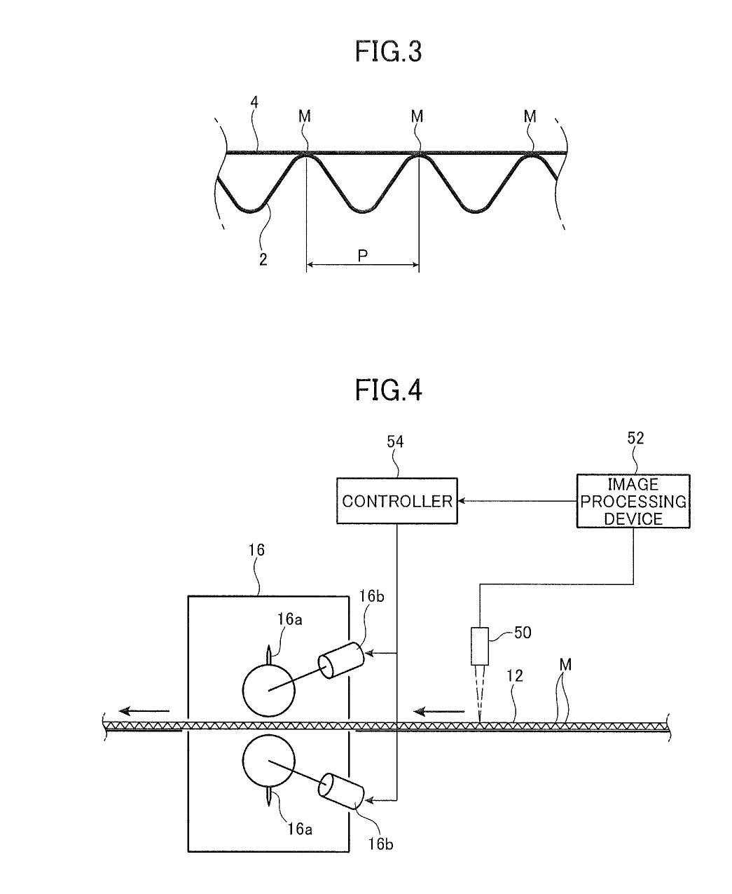

Based on FIGS. 2 and 3, the single facer 8 and its peripheral devices will be described below. The single facer 8 comprises a flute roller 34 for forming a plurality of wave-shaped flutes in the medium 2. The flute roller 34 is composed of an upper roller 34a having a surface formed with a plurality of wave-shaped flutes, and a lower roller 34b disposed just below and in meshed relation with the upper roller 34a, and configured to form the wave-shaped flutes in the medium 2 when it is fed between the upper roller 34a and the lower roller 34b.

A gluing roller 36 is disposed on lower right side of the upper roller 34a to apply a glue to flute tips of the medium 2. In a direction along which the liner 4 is fed in a region upward of the upper roller 34a, a press roller 38 is disposed on an upstream side, and a support roller 40 is disposed on a downstream side, with respect to the upper roller 34a. The press roller 38 is configured to apply a given pressure to the medium 2 and the liner 4, thereby joining them together in a gluing manner. Due to the pressing force of the press roller 38, a plurality of relatively shallow press marks M are formed on a surface of the liner 4 (of the single-faced corrugated sheet 6), more specifically, at positions of the surface of the liner 4 where it is joined to the respective flute tips of the medium 2, as illustrated in FIG. 3.

Further, as illustrated in FIG. 2, a brake device (not illustrated) is connected to a rotary shaft 42 holding a liner material in the liner mill roller stand 22, to apply a tension T to the liner 4, and configured to apply the tension T to the liner 4 during an operation of bonding the medium 2 and the liner 4 together around the upper roller 34a. A brake force of the brake device can be adjusted by a brake controller 44.

The single facer 8 further comprises: a CCD camera 46 provided on the side of an outlet of the single facer 8 to detect an image of the press marks M formed on the surface of the single-faced corrugated sheet 6 so as to serve as an image detection device, and an image processing device 48 for processing the image of the press marks M detected by the CCD camera 46. The image detection device 48 is configured to measure an interval between adjacent ones of the press marks detected by the CCD camera 46, and calculate a value (length) of a flute pitch P in the single-faced corrugated sheet (see FIG. 3), based on the measured interval. Alternatively, the image detection device 48 may be configured to detect the number of press marks per unit distance (e.g., 300 mm) along the moving direction F1, and calculate a value (length) of the flute pitch P in the single-faced corrugated sheet, based on the detected number of press marks. As above, in this embodiment, a combination of the image detection device (CCD camera 46) for detecting an image of the press marks M and the image processing device 48 for processing the detected image of the press marks M makes up a flute pitch detection unit for detecting the flute pitch P of the single-faced corrugated sheet 6.

Based on FIG. 4, the cutter machine 16 and its peripheral devices will be described below. The cutter machine 16 comprises a pair of cutters 16a disposed in an up-down direction to cut a double-faced corrugated sheet into a plurality of sheets each having a given length L, and two electric motors 16b for driving the cutters 16a, respectively. The cutter machine 16 is configured to control the cutters 16a according to the electric motors 16b, in such a manner that a rotational speed of the cutters 16a is maintained constant during cutting of the double-faced corrugated sheet (constant speed region), and variably changed during a non-cutting mode (variable speed region), as described later.

The cutter machine 16 also comprises: a CCD camera 50 provided on an upstream side with respect to the cutter machine 16 to detect an image of press marks on a surface of the double-faced corrugated sheet 12 so as to serve as a second image detection device, and a second image processing device 52 for processing the image of the press marks M detected by the CCD camera 50. The CCD camera 50 is configured to detect an image of the press marks M at a position of the CCD camera 50, and the second image processing device 52 is configured to calculate a position of each of the press marks M (position of each of the flute tips).

The cutter machine 16 further comprises a controller 54. The controller 54 is operable, when, with respect to a cut position (flute tip position) of the double-faced corrugated sheet 12 set by the cutter machine 16, a corresponding one of the positions of the press marks M has a deviation, to adjust the rotational speed of the electric motors 16b for driving the cutters 16a of the cutter machine 16, thereby correcting an amount of the deviation to allow the double-faced corrugated sheet to be cut at respective desired flute tip positions so as to obtain a plurality of double-faced corrugated sheets each having the given length L (see FIG. 7(B)). The above correction of the deviation amount is performed within a cutting accuracy range of the cutters 16a of the cutter machine 16.

As above, in this embodiment, a combination of the second image detection device (CCD camera 50) for detecting an image of the press marks M and the second image processing device 52 for processing the detected image of the press marks M makes up a flute pitch detection unit for detecting a phase of each flute tip of double-faced corrugated sheet 12.

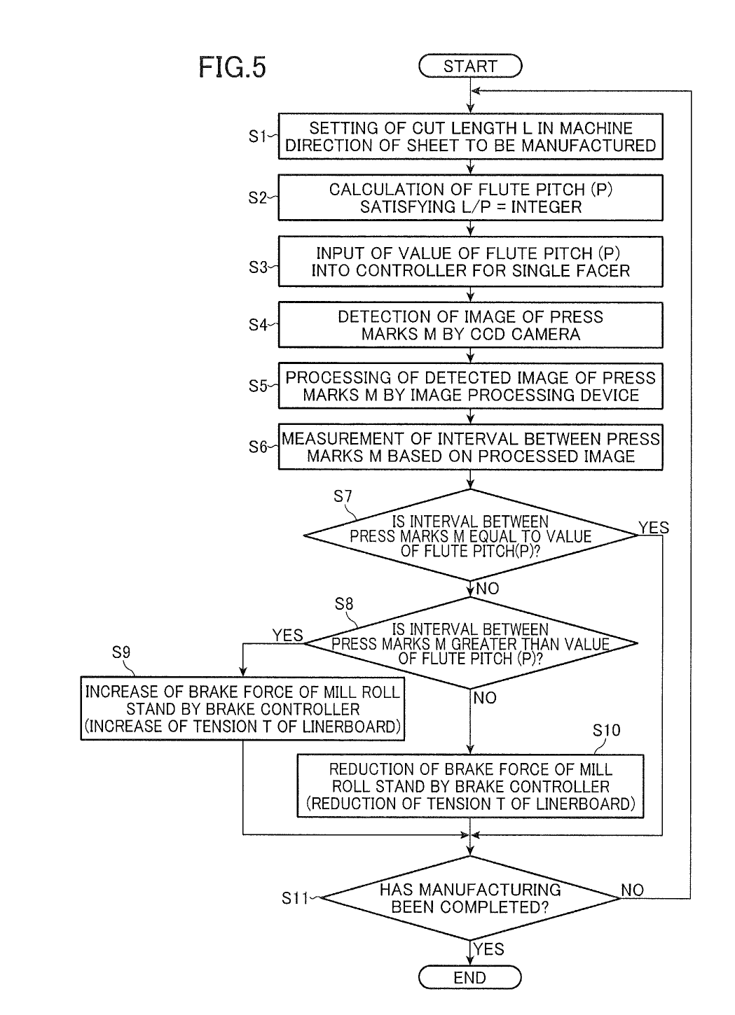

Based on FIG. 5, a control flow in the single facer 8 (see FIG. 2) will be described below. In FIG. 5, the code S denotes each step.

First, in S1, the cut length L in the moving direction F1 of a corrugated sheet (double-faced corrugated sheet) to be manufactured is set (see FIG. 7(A)). A flute direction in a corrugated sheet is a direction perpendicular to the moving direction F1. Then, in S2, the flute pitch P of the medium is calculated and set in such a manner that the cut length L becomes equal to an integral multiple of the flute pitch P of the medium.

Then, the process advances to S3, wherein a value of the flute pitch P obtained by the calculation is input into a controller for the single facer 8. The process advances to S4, wherein an image of the press marks M on the surface of the single-faced corrugated sheet is detected by the CCD camera 46. The process advances to S5, wherein the detected image of the press marks M is processed. The process advances to S6, wherein an interval between the press marks M (=detected flute pitch) is measured by the processed image of the press marks M.

Then, the process advances to S7, wherein it determined whether or not the measured interval between the press marks M (=detected flute pitch) is equal to the value of the flute pitch P set in the S2. If YES, the process advances to S11. If NO, the process advances to S8, wherein it is determined whether or not the measured interval between the press marks M is greater than the set value of the flute pitch P. If YES, the process advances to S9, wherein a brake force of the liner mill roller stand 22 is increased by the brake controller 44, to thereby increase the tension T of a liner being fed into the single facer. In response to increasing the tension T of the liner, a value of the flute pitch P is reduced to become equal to the set value.

On the other hand, if NO, the process advances to S10, wherein the brake force of the liner mill roller stand 22 is reduced by the brake controller 44, to thereby reduce the tension T of the liner being fed into the single facer 8. In response to reducing the tension T of the liner, the value of the flute pitch P is increased to become equal to the set value. After the S9 or S10, the process advances to S11, wherein it is determined whether the manufacturing of corrugated sheets has been completed. If NO, the process returns to the S1.

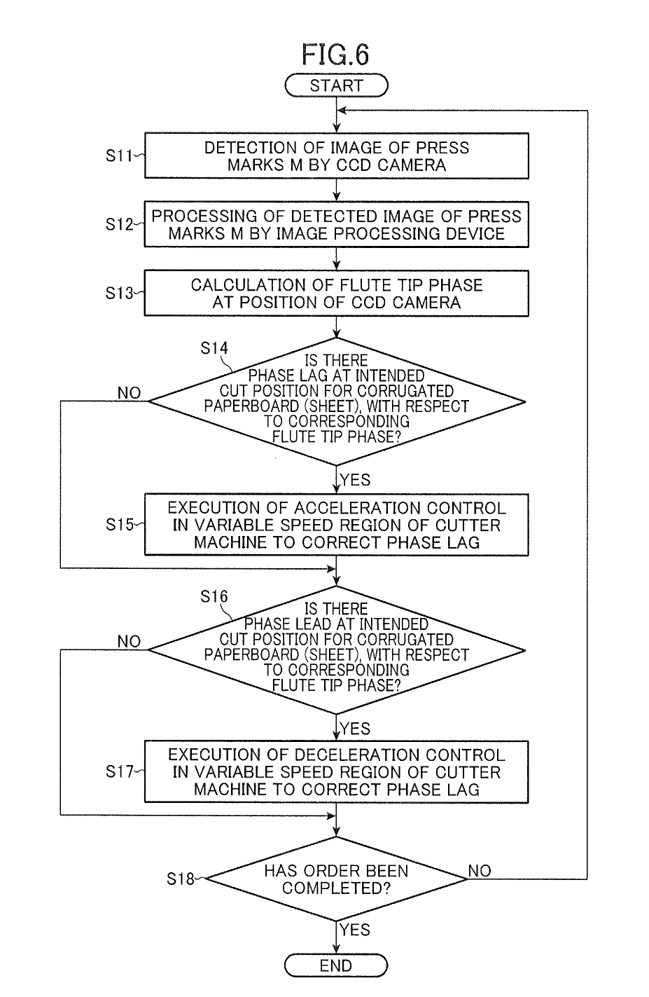

Based on FIG. 6, a control flow, a control flow in the cutter machine 16 (see FIG. 4) will be described below. In FIG. 6, the code S denotes each step.

First, in S11, an image of the press marks M is detected by the CCD camera 50, on an upstream side with respect to the cutter machine 16. Then, in S12, the detected image of the press marks M is processed by the image processing device 51. Then, in S13, a phase of each flute tip at a position of the CCD camera 50 is calculated. Then, in S14, it is determined whether or not there is a phase lag at an intended cut position for the corrugated sheet, with respect to a corresponding flute tip phase at the position of the CCD camera 50. When there is the phase lag, the process advances to S15, wherein, in the aforementioned variable speed region of the cutter machine 16, an acceleration control operation is performed to increase the rotational speed of the cutters 16a of the cutter machine so as to correct the phase lag. Based on the acceleration control, the phase lag at the intended cut position for the corrugated sheet is corrected to allow the corrugated sheet (double-faced corrugated sheet 12) to be cut at the same position in the flute tip phase (position of each flute tip).

Then, in S16, it is determined whether or not there is a phase lead at the intended cut position for the corrugated sheet, with respect to the corresponding flute tip phase at the position of the CCD camera 50. If YES, the process advances to S17, wherein, in the variable speed region of the cutter machine 16, a deceleration control operation is performed to reduce the rotational speed of the cutters 16a of the cutter machine so as to correct the phase lead. Based on the deceleration control, the phase lead at the intended cut position for the corrugated sheet is corrected to allow the corrugated sheet (double-faced corrugated sheet 12) to be always cut at the phase of each flute tip (position of each flute tip).

Then, the process advances to S18, wherein it is determined whether a current order has been completed.

The corrugated sheet manufacturing apparatus according to the above embodiment of the present invention exerts the following excellent functions and effects.

In the corrugated sheet manufacturing apparatus according to the embodiment of the present invention, the flute pitch P of the medium is set in the single facer in such a manner that the cut length L in the moving direction F1 of the corrugated sheet becomes equal to an integral multiple of the set flute pitch, so that it becomes possible to allow a plurality of corrugated sheets each cut to the given length in the moving direction F1 (double-faced corrugated sheets 12) to become uniform in terms of the flute tip phase.

In addition, the CCD camera 46 is used to detect an image of the press marks M on the surface of the single-faced corrugated sheet 6 and measure the interval between the press marks M. Then, when the interval (=flute pitch) is greater than a set value of the flute pitch P, the brake force of the liner mill roller stand 22 is increased, so that the tension T of a liner being fed into the single facer is increased to reduce a feed amount of the liner 4, thereby allowing the interval between the press marks M to become equal to the set value of the flute pitch P. On the other hand, when the interval between the press marks M is less than the set value of the flute pitch P, the tension T of the liner is reduced to increase the feed amount of the liner 4, thereby allowing the interval between the press marks M to become equal to the set value of the flute pitch P. Thus, it becomes possible to allow a plurality of corrugated sheets (double-faced corrugated sheets 12) to become uniform in terms of a flute phase.

Further, the press marks M to be detected using the CCD camera 46 are formed on the surface of the liner by the press roller, so that it becomes possible to reliably detect a phase deviation of the flute pitch.

In the corrugated sheet manufacturing apparatus according to the above embodiment, the press marks M appearing on the surface of the corrugated sheet are detected by using the CCD camera 46. Alternatively, flute tips of the single-faced corrugated sheet may be detected by imaging the flute tips from a top or side surface of the corrugated sheet. In this case, the tension T of the liner is adjusted to allow an interval between adjacent ones of the flute tips of the single-faced corrugated sheet to become equal to the set flute pitch.

Furthermore, the CCD camera 46 is used as an image detection device, so that it becomes possible to detect a phase deviation of each flute simply and accurately.

More specifically, in the corrugated sheet manufacturing apparatus according to the above embodiment of the present invention, as illustrated in FIGS. 7(A) and 7(B), the plurality of double-faced corrugated sheets 12 (a 1st sheet, a 2nd sheet, - - - , an nth sheet) become uniform in terms of a flute phase in the medium 2 in which flutes are formed in a direction perpendicular to the moving direction F1.

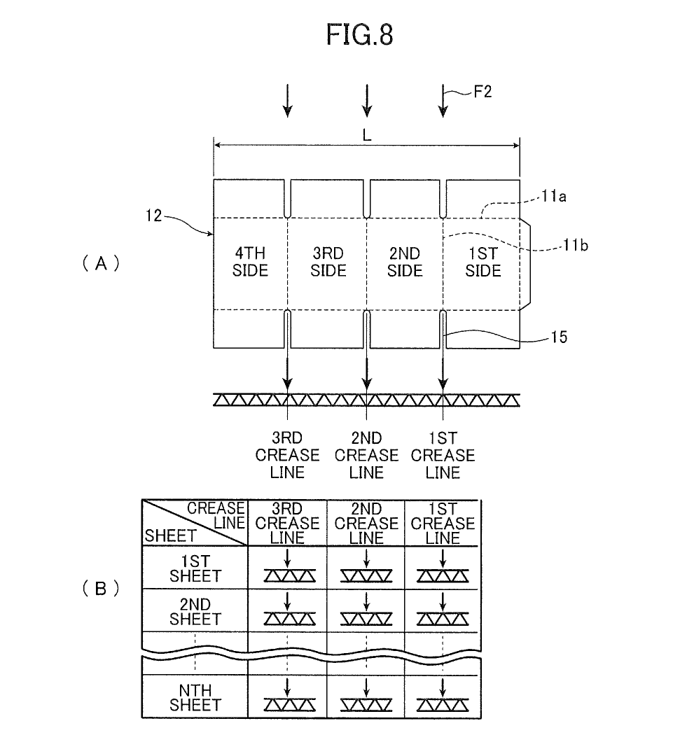

To each of the double-faced corrugated sheets cut to the length L by the cutter machine 16, an operation of forming therein a plurality of crease lines 11 and a plurality of slots 15 is carried out along a width direction F2 perpendicular to the moving direction F1 in the aforementioned corrugated sheet manufacturing apparatus, during a subsequent box making, by a creaser-slotter (not illustrated) of a box making machine (not illustrated), as illustrated in FIG. 8(A). Each of the crease lines 11b, i.e., 1st to 3rd crease lines is located at the same position (crease line position) (i.e., at the same phase) in the double-faced corrugated sheets (the 1st sheet, the 2nd sheet, - - - , the nth sheet). Therefore, a variation in foldability at respective positions of the crease lines 11b during folding using the box making machine is suppressed.

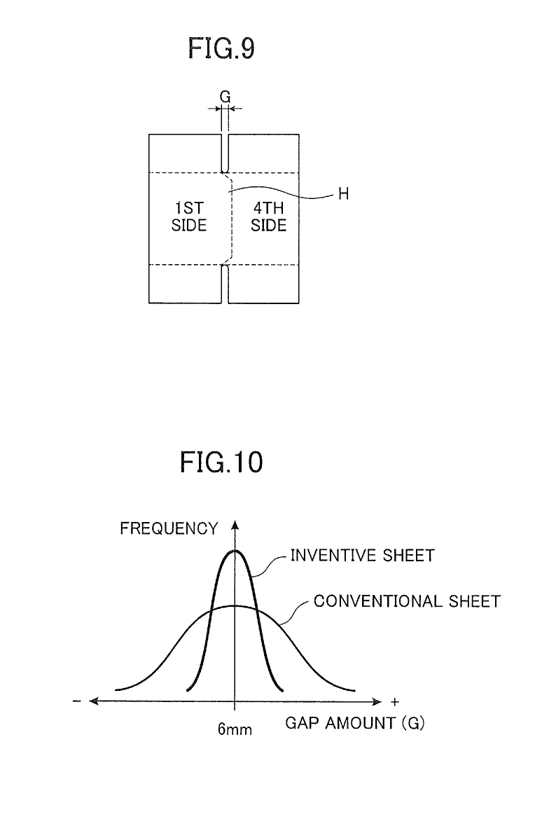

As a result, a variation in gap amount G (e.g., a given dimension of 6 mm) in a bonded region H illustrated in FIG. 9 becomes smaller than before, as illustrated in FIG. 10. As above, in the case where a corrugated box is made by the corrugated sheet manufacturing apparatus according to the above embodiment, each of a plurality of double-faced corrugated sheets each cut to the given length L by the cutter machine can be joined with enhanced accuracy in the box making step, thereby providing further uniformized box size.

In the corrugated sheet manufacturing apparatus according to the above embodiment of the present invention, in a situation where, before cutting of the double-faced corrugated sheet 12, a flute tip phase in the double-faced corrugated sheet 12 deviates from a flute tip phase at an intended cut position, an amount of the deviation is corrected to fall within a given range (within a cutting accuracy range of the cutter machine 16), so that, when the double-faced corrugated sheet 12 is cut into a plurality of sheets each having the cut length L, the cut area can be set at the same position (position of each flute tip) in the flute phase of the corrugated sheet, so that it becomes possible to allow the plurality of corrugated sheets to become uniform in terms of a cut position (see FIG. 7(B)). As a result, it becomes possible to provide further enhanced joining accuracy of the corrugated sheet in the subsequent box making step.

If a phase in the cut area of the corrugated sheet largely deviates from a position of a tip or trough (bonding position) of each flute, a problem “whisker” occurs in which whisker-like chips hang down from the cut area (see Paragraph [0003] and FIG. 9 in JP 06-339894A). The corrugated sheet manufacturing apparatus according to the above embodiment of the present invention can uniformly set a cut position by the cutter machine, to a tip or trough of each flute, so that it becomes possible to effectively prevent the occurrence of the “whisker”.

What is claimed is:

1. A corrugated sheet manufacturing apparatus for manufacturing a corrugated sheet, on which a plurality of fold lines are formed, and which are folded and joined along positions of the fold lines to produce a corrugated box, using a box making machine, the corrugated sheet manufacturing apparatus comprising:
a single facer for producing a single-faced corrugated sheet by bonding a liner to a medium formed with a plurality of flutes having a given flute pitch to produce;
a double facer for producing a double-faced corrugated sheet by bonding another liner to the single-faced corrugated sheet; and
a cutter machine for cutting the double-faced corrugated sheet into a plurality of sheets each having a given cut length in a moving direction of the sheet,
wherein the single facer comprises:
a flute pitch calculation unit for calculating and setting a value of the flute pitch of the medium in such a manner that the cut length for the double-faced corrugated sheet becomes equal to an integral multiple of the flute pitch of the medium;
a flute pitch detection unit for detecting a flute pitch of the single-faced corrugated sheet fed out from the single facer; and
a tension adjustment unit for adjusting a tension of a liner being fed into the single facer to allow the flute pitch of the single-faced corrugated sheet detected by the flute pitch detection unit to become equal to the flute pitch set by the flute pitch calculation unit.

2. The corrugated sheet manufacturing apparatus according to claim 1, wherein the flute pitch detection unit comprises:
an image detection device provided on the side of an outlet of the single facer to detect an image of a surface of the fed-out single-faced corrugated sheet; and
an image processing device for processing the image detected by the image detection device to detect the flute pitch of the single-faced corrugated sheet.

3. The corrugated sheet manufacturing apparatus according to claim 2, wherein the single facer further comprises a press roller for pressing the liner against the medium to bond them together, and the image detection device detects a plurality of press marks formed on a surface of the liner by the press roller.

4. The corrugated sheet manufacturing apparatus according to claim 2, wherein the image detection device detects an image of a plurality of flute tips of the single-faced corrugated sheet.

5. The corrugated sheet manufacturing apparatus according to claim 2, wherein the image detection device is a CCD camera.

6. The corrugated sheet manufacturing apparatus according to claim 1, wherein the cutter machine comprises:
a flute tip phase detection unit for, before the cutting of the double-faced corrugated sheet, detecting phases of a plurality of flute tips of the double-faced corrugated sheet; and
a speed control unit for, when, with respect to a flute tip phase at an intended cut position, a corresponding one of the phases of the flute tips of the double-faced corrugated sheet detected by the flute tip phase detection unit has a deviation, controlling a rotational speed of a cutting tool of the cutter machine, thereby correcting an amount of the deviation to fall within a given range.

7. The corrugated sheet manufacturing apparatus according to claim 6, wherein the flute tip phase detection unit comprises:
an image detection device for detecting an image of a surface of the double-faced corrugated sheet; and
an image processing device for processing the image detected by the image detection device to detect the phases of the flute tips of the double-faced corrugated sheet.
